(19) United States
(12) Patent Application Publication
(10) Pub. No.: US 2014/0372178 A1
(43) Pub. Date: Dec. 18, 2014

(54) CORRELATING PRODUCT SALES TO STORE SEGMENTATION

(71) Applicant: Target Brands, Inc., Minneaplis, MN (US)

(72) Inventors: Ping-Fong Hsieh, Plymouth, MN (US); Earl S. Sun, Chaska, MN (US); Daniel W. Peterson, New Hope, MN (US)

(21) Appl. No.: 13/920,582

(22) Filed: Jun. 18, 2013

(51) Int. Cl. G06Q 30/02

(52) U.S. Cl. CPC G06Q 30/0204
USPC 705/7.33

(57) ABSTRACT

Past sales data for a product sold at stores in a chain of retail stores is received by a computing device. For each segment, the stores in the chain are grouped into one or more clusters. The average sales of the product in each cluster and the average sales of the product in all of the stores are calculated based on the past sales data. A cluster variation and a total variation may be determined for each of the stores based on the past sales data. A correlation indicative of an effectiveness of the segmentation strategy to reduce sales variation between stores in each of the plurality of clusters may also be determined based on the at least cluster variation.

### TECHNICAL FIELD

This disclosure relates to systems and methods for analyzing sales data.

### BACKGROUND

Consumers may purchase various products via retail stores. More specifically, retail stores may represent the final point of sale (“POS”) before an end-user gains possession of a product. To this end, retail stores may stock and sell a wide variety of products, and may cater to large customer demands. For example, modern retail stores can cover areas exceeding 120,000 square feet (11,148 square meters). Larger versions of these retail stores, such as so-called “super stores,” may cover areas exceeding 170,000 square feet (or 15,793 square meters). As retail stores gain area and variety of products that they carry, the placement and arrangement of products within a retail store is becoming a more relevant, complex, and intricate inquiry.

To improve sales performance, large retail chains that operate large numbers of stores at different locations will allocate different product assortments to different groups of stores within the chain. This strategy of merchandising retail products is often called store segmentation. The success of a store segmentation strategy is borne out in the resultant product sales performance.

### SUMMARY

In general, this disclosure is directed to determining a correlation between the sales performance of a product and one or more store segmentation strategies. Additionally, examples according to this disclosure are directed to determining a correlation between sales performance of one or more products sales and a number of different store segmentation strategies and generating a report that provides an ordered correlation between product sales for the one or more products s and the different segments of those stores considered by the retailer.

In one example, the disclosure is directed to a method including receiving, by a computing device, past sales data for a product sold at a plurality of stores, assigning each of the plurality of stores to one of a plurality of clusters based on a segmentation strategy, calculating a cluster average sales of the product for each of the plurality of clusters based on the past sales data for each of the stores assigned to the cluster, for each of the plurality of stores, calculating a cluster variation based on a difference between actual sales of the product in the store indicated by the past sales data and the calculated cluster average sales for the cluster to which the store is assigned, calculating a total average sales of the product based on the past sales data for each of the plurality of stores and the total number of stores in the plurality of stores, for each of the plurality of stores, calculating a total variation based on a difference between actual sales of the product in the store and the calculated total average sales, and determining a correlation score based on the cluster variation and the total variation, the correlation indicative of an effectiveness of the segmentation strategy to reduce sales variation for the product between stores in each of the plurality of clusters.

In another example, the disclosure is directed to a system including at least one computer-readable storage device that stores sales data associated with a product sold at a plurality of stores, that stores a first segmentation strategy that assigns each of the plurality of stores to one of a first plurality of clusters within a first segment, and that stores a second segmentation strategy that assigns each of the plurality of stores to one of a second plurality of clusters within a second segment, at least one processor configured to access the sales data on the at least one computer-readable storage device, and further configured to determine a first correlation score for the first segment based on the sales data, the first correlation score indicative of an effectiveness of the first segmentation strategy to reduce sales variation for the product between stores in each of the first plurality of clusters, determine a second correlation score for the second segment based on the sales data, the second correlation score indicative of an effectiveness of the second segmentation strategy to reduce sales variation for the product between stores in each of the second plurality of clusters, and generate a report based on the first correlation score and the second correlation score.

In another example, the disclosure is directed to a non-transitory computer-readable storage medium encoded with instructions that, when executed by one or more processors, cause the one or more processors of a computing device to receive, by a computing device, past sales data for a product sold at a plurality of stores, assign each of the plurality of stores to one of a plurality of clusters based on a segmentation strategy, calculate a cluster average sales of the product for each of the plurality of clusters based on the past sales data for each of the stores assigned to the cluster, for each of the plurality of stores, calculate a cluster variation based on a difference between actual sales of the product in the store indicated by the past sales data and the calculated cluster average sales for the cluster to which the store is assigned, calculate a total average sales of the product based on the past sales data for each of the plurality of stores and the total number of stores in the plurality of stores, for each of the plurality of stores, calculate a total variation based on a difference between actual sales of the product in the store and the calculated total average sales, and determine a correlation score based on the cluster variation and the total variation, the correlation indicative of an effectiveness of the segmentation strategy to reduce sales variation for the product between stores in each of the plurality of clusters.

The details of one or more examples are set forth in the accompanying drawings and the description below. Other features and advantages will be apparent from the description and drawings, and from the claims.

### BRIEF DESCRIPTION OF DRAWINGS

FIG. 1 is a graph illustrating the relationship between the percentage of product sales correlated with segmentation and the segmentation level.

FIG. 2 is a block diagram illustrating an example system that may be used to evaluate the potential impact of segmentation strategies on product sales.

FIG. 3 is a block diagram illustrating an example sales to segment correlation engine.

FIG. 4 is a flowchart illustrating one example method of determining correlations between product sales and different segmentation strategies.

FIG. 5 is an example report of sales data for a product sold in stores of a retailer and correlation scores between the sales of the product and one segmentation strategy employed by a retailer.

FIG. 6 is an example sales-to-segment correlation report that provides an ordered correlation between product sales for a number of different products and different segmentation strategies employed by a retailer.

### DETAILED DESCRIPTION

Examples according to this disclosure are directed to determining the correlation between sales performance of a product and a store segmentation strategy. Additional examples according to this disclosure are directed to determining the correlation between sales performance of one or more products and one or more store segmentation strategies. The examples may also include generating one or more reports indicative of the correlation between product sales for the one or more products and the one or more segmentation strategies. Such a sales-to-segment correlation (SSC) report for the one or more products may provide the retailer with an efficient mechanism for evaluating different segmentation strategies on a product-by-product basis, as well as for evaluating different segmentation strategies for a number of related products such as products in a common category or sold in a common department.

Retail chains may allocate different product assortments to different groups of stores within the chain. This strategy of merchandising retail products may be referred to as store segmentation. Within each segment, the stores of the chain may be further broken up into a number of groups, or “clusters.” Stores in the same segment are considered to share some characteristic with one another. The common characteristic upon which the stores are segmented may be referred to as a segmentation criterion or, if there are multiple characteristics shared by stores in a segment, segmentation criteria.

Segmentation allows retailers to, in effect, customize product offerings at each store or group of stores based on customer demand. In theory, therefore, it would generally improve sales to provide a segmentation strategy that provides a different product assortment to each individual store in the chain, as the customer demands between any two different stores may vary based on one or more factors. Segmentation, however, may generally be associated with increased costs for the retailer. For example, it may be more complex and costly to plan for and deliver 10 different product assortments to 100 different stores than to plan for and deliver 5 different assortments to 100 different stores. As such, the level of granularity provided by a segmentation strategy, e.g., how many different product assortments are offered by the stores in the chain, will be related to associated segmentation costs.

The incremental sales increase realized as a result of segmentation may increase quickly at lower levels of segmentation and then increase less quickly as the number of levels of segmentation increases. The “levels” of a segmentation strategy may refer to the number of unique assortments delivered to the stores, which generally corresponds to the number of clusters defined by the segmentation strategy. As such, segmentation level may be referred to as the number of clusters in a segment.

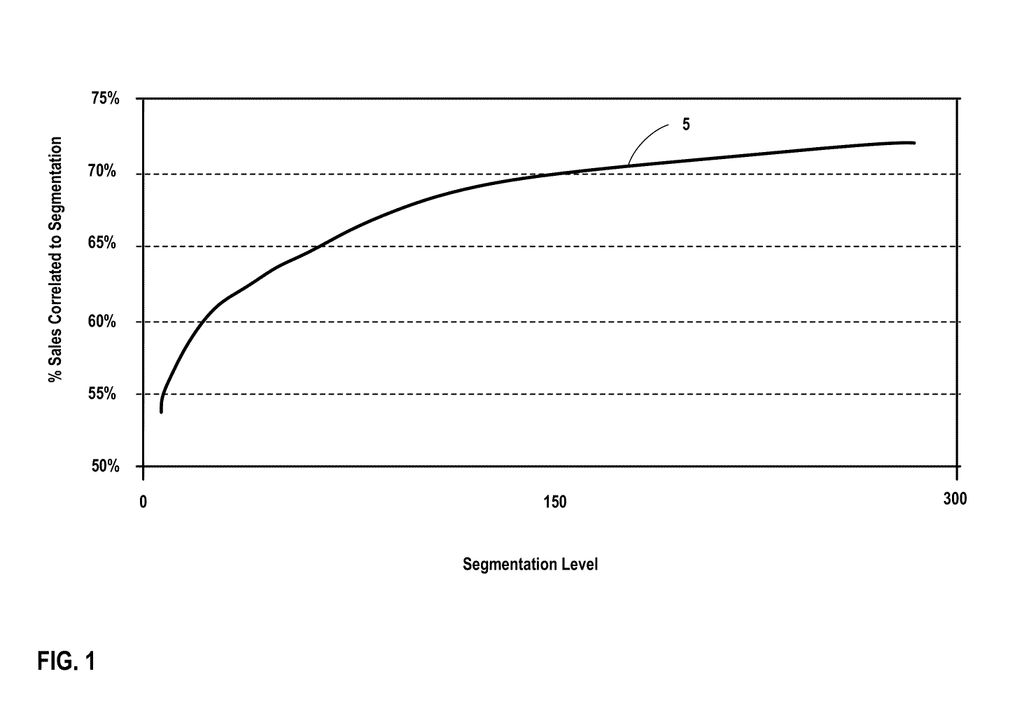

The relationship between the incremental sales benefit of segmentation and the number of levels or clusters in the segment is illustrated in the example graph of FIG. 1. In FIG. 1, curve 5 illustrates an example relationship between the amount (in this case percent) that sales of a group of products is correlated to a segmentation strategy implemented by a retailer and the number of levels or clusters defined by the segmentation strategy. As illustrated in FIG. 1, the incremental sales increase realized increases quickly (e.g., exponentially) at relatively lower levels of segmentation and then increases less quickly as the number of levels of segmentation increases.

Because of the increasing costs of segmentation and the diminishing returns as the number of levels of the segmentation increases, a retailer may benefit from tools that enable the retailer to evaluate segmentation strategies for individual products. Such tools may also be beneficial for evaluating segmentation strategies across groups of products, such as products that are related by shared characteristics (sometimes referred to as a product category), products that are related by where and how they are displayed in a store (as in products that share the same department in a store). Examples according to this disclosure are directed to providing systems that provide a correlation between product sales for one or more products and one or more segmentation strategies. The system may further generate one or more reports, such as a sales-to-segment correlation report. The analysis may provide retailers with a mechanism to evaluate the potential impact of one or more segmentation strategies on a product or group of products.

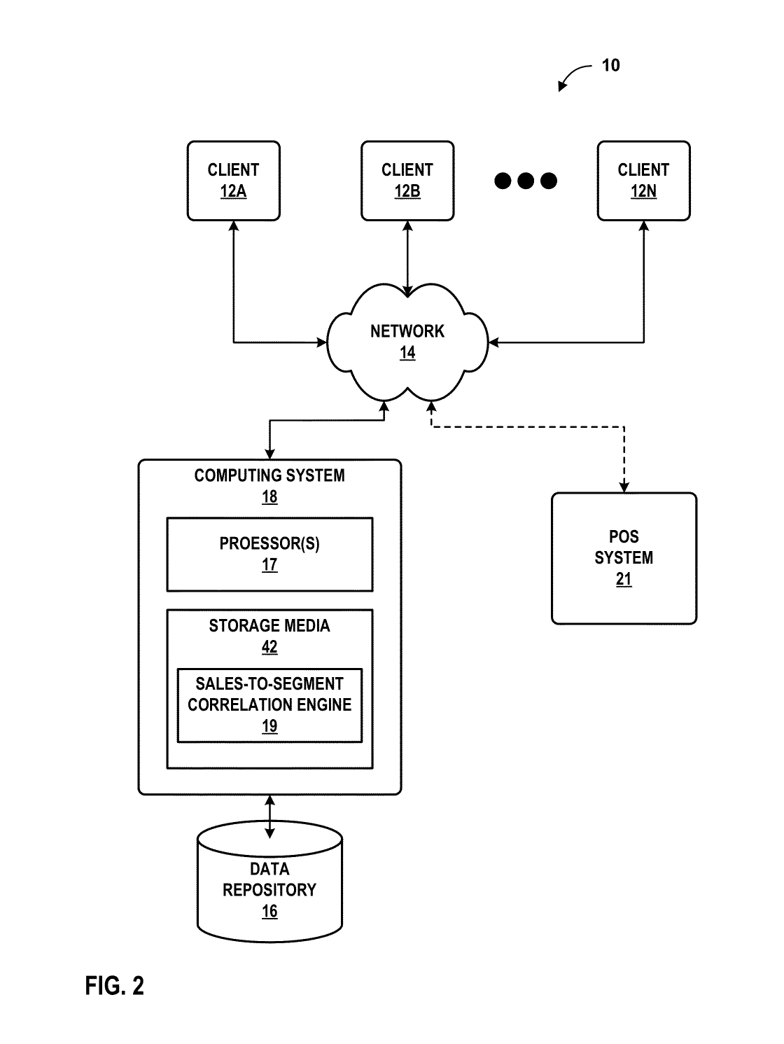

FIG. 2 is a block diagram illustrating example system 10 configured to execute the segmentation analysis of the present disclosure. System 10 includes one or more client computing devices 12A-12N (collectively “clients 12” or individually “client 12”), one or more network(s) 14, a data repository 16, a computing system 18, and a point-of-sale (POS) system 21. Clients 12 are communicatively coupled with data repository 16, computing system 18, and POS system 21 via network(s) 14. Clients 12 and system 18 are configured to periodically communicate with one another over network 14 to track and store, e.g., in data repository 16, product sales data associated with various products sold by a retailer, e.g., sales data retrieved from or communicated by POS system 21.

Computing system 18 includes one or more storage media 42. Storage media 42 includes a sales-to-segment correlation (SSC) engine 19 which includes instructions that, when executed by processor(s) 17, permit system 10 to perform an analysis of the sales data provided by POS system 21. SSC engine 19 is configured to determine, for example, a correlation between sales of one or more products for each of one or more store segmentation strategies. SSC engine 19 may be further configured to generate one or more reports that indicate, among other things, the correlation determined for each of the one or more segmentation strategies and/or provide an ordered correlation of the one or more segmentation strategies. In this manner, system 10 and/or other systems including similar capabilities may be employed by the retailer to gauge the potential impact of different segmentation strategies on a product or group of products sold by the retailer.

Clients 12 may include any number of different portable electronic mobile devices, including, e.g., cellular phones, personal digital assistants (PDA's), laptop computers, portable gaming devices, portable media players, e-book readers, watches, as well as non-portable devices such as desktop computers. Clients 12 may include one or more input/output devices configured to allow user interaction with one or more programs configured to communicate with computing system 18 and SSC engine 19. For example, clients 12 may be client computers from which users may access and interact with SSC engine 19. In one example, clients 12 may run a web browser that accesses and presents a web application executed by computing system 18 or another device and allows a user to generate a report including sales transaction data for one or more items sold by the retailer. In another example, clients 12 may execute an application outside of a web browser, e.g., an operating system specific application like a Windows application or Apple OS application that accesses and presents information processed by SSC engine 19 on computing system 18 or another device. In another example, one or more of clients 12 may store and execute SSC engine 19 locally.

Network 14 may include one or more terrestrial and/or satellite networks interconnected to provide a means of communicatively connecting clients 12 and POS system 21 with computing system 18 and data repository 16. For example, network 14 may be a private or public local area network (LAN), Wide Area Network (WANs), or the internet. Network 14 may include both wired and wireless communications. For example, network 14 may include wireless communications according to one of the 802.11 or Bluetooth specification sets, or another standard or proprietary wireless communication protocol. Network 14 may also include communications over a terrestrial cellular network, including, e.g., a GSM (Global System for Mobile Communications), CDMA (Code Division Multiple Access), EDGE (Enhanced Data for Global Evolution) network. Data transmitted over network 14, may be formatted in accordance with a variety of different communications protocols. For example, all or a portion of network 14 may be a packet-based, Internet Protocol (IP) network that communicates data from clients 12 to data repository 16 in Transmission Control Protocol/Internet Protocol (TCP/IP) packets, over, e.g., Category 5, Ethernet cables.

Data repository 16 and/or POS system 21 may each include a standard or proprietary electronic database or other data storage and retrieval mechanism. For instance data repository 16 and/or POS system 21 may each include one or more databases, such as relational databases, multi-dimensional databases, hierarchical databases, object-oriented databases, or one or more other types of databases. Data repository 16 and/or POS system 21 may be implemented in software, hardware, and combinations of both. For example, data repository 16 and/or POS system 21 may include proprietary database software stored on one of a variety of storage mediums on a data storage server connected to network 14 and configured to store information associated with sales of products or other items at various locations of a retailer. Storage media included in or employed in cooperation with data repository 16 and/or POS system 21 may include, e.g., any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

Data repository 16 and/or POS system 21 may store information associated with sales of products and other items of the retailer. Examples of such information may include past actual sales transactions for the various products sold by the retailer at one or more stores in the chain. In one example, POS system 21 receives and processes sales data associated with customer transactions of the retailer at various locations of the retailer. Computing system 18 may periodically retrieve or request raw POS sales transaction data from POS system 21 and may store the data or may process and store the data in data repository 16. In another example, POS system 21 may be configured to periodically “push” the sales data over network 14 to server 18 and/or data repository 16.

Computing system 18 may include any of several different types of devices. For example, server 18 may include a data processing appliance, web server, specialized media server, personal computer operating in a peer-to-peer fashion, or another type of network device. SSC engine 19 may be implemented in hardware, software, or a combination of both and may include one or more functional modules configured to execute various functions attributed to SSC engine 19. Additionally, although example system 10 of FIG. 2 includes one computing system 18, other examples may include a number of collocated or distributed computers configured to process sales and other types of data associated with products and other items sold by the retailer and stored in data repository 16 individually or in cooperation with one another.

Although data repository 16, computing system 18, and POS system 21 are illustrated as separate components in example system 10 of FIG. 2, in other examples the components may be combined or may each be distributed amongst more than one device. For example, computing system 18 may manage data repository 16 and control the repository to periodically retrieve sales data from POS system 21 over network 14. In another example, data repository 16 and/or POS system 21 may be distributed among a number of separate devices, e.g., a number of database servers, and computing system 18 may include a number of co-located or distributed computing devices configured to operate individually and/or in cooperation with one another and with the various devices comprising data repository 16 and/or POS system 21.

Regardless of the particular configuration of system 10, or other example systems capable of implementing the techniques of this disclosure, system 10 may analyze one or more segmentation strategies for each of one or more products. For each product analyzed, SSC engine 19 may determine one or more values indicative of relationships between sales of the product and one or more segmentation strategies. For example, SSC engine 19 may determine a “cluster variation” indicative of a difference between sales of a product in an individual store and average sales of the product across all stores in the cluster of which the store is a member. As another example, SSC engine 19 may determine a “total variation” indicative of a difference between sales of a product in an individual store and total average sales of the product across all of the stores in the segment. As another example, SSC engine 19 may determine a “correlation score” based on the cluster variations and the total variations for all stores in the segment. The correlation score may be indicative of the amount of variation the particular segmentation strategy can reduce. In other words, the correlation score may be indicative of an effectiveness of the segmentation strategy to reduce sales variation between stores in each of the plurality of clusters. The cluster variation, total variation, and correlation score will be described in more detail below.

SSC engine 19 may repeat this process for each of the one or more products sold by the retailer. The results of this analysis may be used by SSC engine 19 to generate one or more reports that provide information concerning the relationship between product sales and the one or more segmentation strategies.

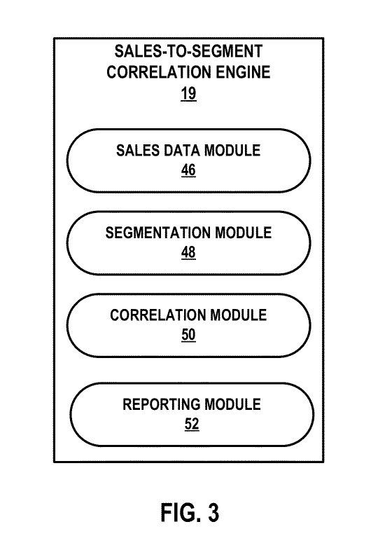

FIG. 3 is a block diagram illustrating an example SSC engine 19 in more detail. SSC engine 19 includes sales data module 46, segmentation module 48, correlation module 50, and reporting module 52. Sales data module 46 of SSC engine 19 may be configured to retrieve, receive, or otherwise reference sales data corresponding to sales of products or other items at one or more stores/locations of a retailer. Sales data module 46 may, for example, retrieve sales data from a data repository such as data repository 16 of FIG. 2 or POS system 21.

Segmentation module 48 includes the one or more segmentation strategies to be analyzed in accordance with the techniques of the disclosure. A segmentation strategy may define, for example, the total number of stores in the segment, the total number of clusters in the segment, the stores that are assigned to each cluster, and the product assortment allotted to each of the clusters. Stores within the same cluster receive the same product assortment; stores in different clusters receive different product assortments. The segments may be based one or more factors that may have an influence on sales of the product. Example segments may include sales volume, climate, BTC (back to college/school), distance to competitor stores, geographic location, young singles, mom and child, etc. The clusters may be based on one or more characteristics believed to be common among the stores in the cluster, which are believed to justify the same product allocation among stores within the cluster.

Correlation module 50 of SSC engine 19 is configured to analyze one or more segmentation strategies applied by segmentation module 48 for each of one or more products. For example, correlation module 50 of SSC engine 19 may determine a “cluster variation” indicative of a difference between sales of a product in an individual store and average sales of the product across all stores in the cluster of which the store is a member. As another example, correlation module 50 may determine a “total variation” indicative of a total difference between sales of a product in an individual store and total average sales of the product across all of the stores under consideration. As another example, correlation module 50 may determine a correlation score based on the cluster variations and the total variations for all stores in the segment. The correlation score may be indicative of the amount of variation within clusters that the particular segmentation strategy can reduce. In other words, the correlation score may be indicative of an effectiveness of the segmentation strategy to reduce sales variation between stores in each of the plurality of clusters. Other calculations may also be made, and the disclosure is not limited in this respect. Correlation module 50 may repeat this process for one or more of the products that sold by the retailer.

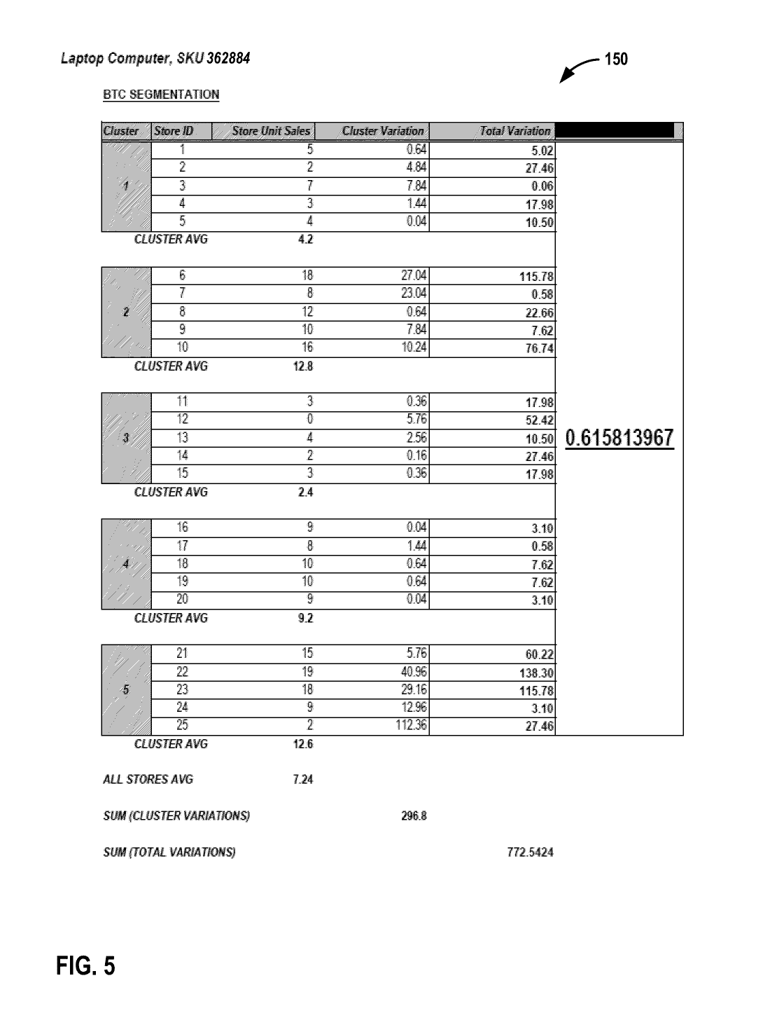

The results of the analysis executed by correlation module 50 may be used by reporting module 52 to generate one or more reports. The reports may provide information concerning the relationship(s) between product sales for each of the one or more products and the one or more segmentation strategies. For example, reporting module 52 may generate a report that includes an ordered correlation between product sales and the different segments of those stores considered (see, e.g., FIG. 5). The example reports might indicate the degree to which one or more segmentation strategies might be able to reduce sales variation across stores in the clusters. As another example, one of sales data module 46, segmentation module 48, and correlation module 50 may generate one or more reports based on the relationships determined by correlation module 50.

Although shown as separate components in FIG. 3, in some examples, one or more of SSC engine 19, sales data module 46, segmentation module 48, correlation module 50, and reporting module 52 may be part of the same module. In some examples, one or more of SSC engine 19, sales data module 46, segmentation module 48, correlation module 50, and reporting module 52 may be formed in a common hardware unit. In some instances, one or more of SSC engine 19, sales data module 46, segmentation module 48, correlation module 50, and reporting module 52 may be software and/or firmware units that are executed on processors 38. It shall thus be understood that the modules of SSC engine 19 are presented separately for ease of description and illustration, and that the disclosure is not limited in this respect.

Additionally, although the foregoing examples have been described with reference to SSC engine 19 including sales data module 46, segmentation module 48, correlation module 50, and reporting module 52, in other examples such function/processing engines or other mechanisms configured to operate in accordance with the disclosed examples may be physically and/or logically differently arranged. For example, SSC engine 19 may include a segmentation module and correlation module, in which one or both of the two modules are configured to retrieve or otherwise reference sales data, e.g., retrieved by computing device 30 from a data repository like data repository 16 of FIG. 2. A wide variety of other logical and physical arrangements are possible in order to implement the functionality attributed to the example of SSC engine 19 illustrated in FIGS. 2 and 3, and the disclosure is not limited in this respect.

Computing device 30 may include operating system 44. Operating system 44, in some examples, controls the operation of components of computing device 30. For example, operating system 44, among other things, facilitates the communication of SSC engine 19 with processors 38, display 32, user interface 34, and communication units 36.

Computing device 30 may include additional components not shown in FIG. 3. For example, computing device 30 may include a battery or other power source to provide power to the components of computing device 30. In addition, the components of computing device 30 need not necessarily be present in every example of computing device 30.

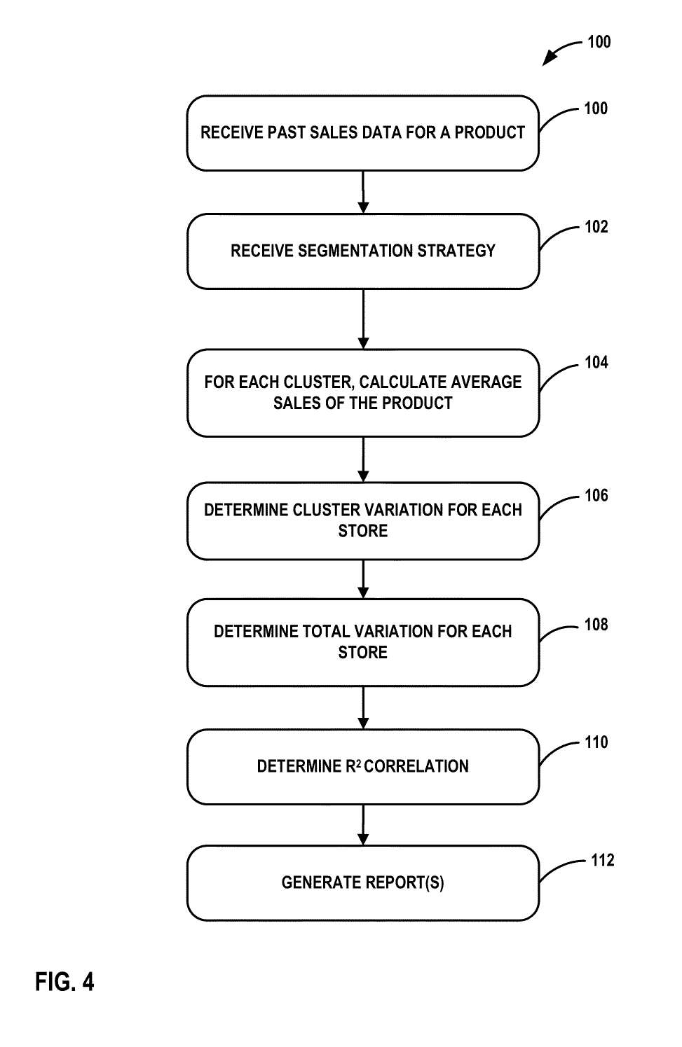

FIG. 4 is a flowchart illustrating an example process by which a computing device, such as computing device 30 or server 18, may determine relationships between product sales for one or more products and one or more segmentation strategies. FIG. 4 illustrates the example process for one product and one segment. However, it shall be understood that the process may be carried out for the same product in multiple segments, so that the segments may be compared to one another. In addition, it shall be understood that the process may be carried out for one or more products and for multiple segmentation strategies for each of those products.

The method of FIG. 4 includes receiving past sales data for a product (100). The segmentation strategy, that is, the definitions for which stores are included in the segment and how the stores are clustered within the segment, is received (102). The average product sales of the product for each cluster is computed based on the past sales data (104). For each store, the computing device may determine a cluster variation (106). For example, the cluster variation for each store may be calculated based on a difference between sales of the product in the store and the calculated average sales of the product in all of the stores of the cluster. For each store, the computing device may further determine a total variation (108). For example, the total variation for each store may be calculated based on a difference between sales of the product in the store and total average sales of the product in all of the stores in all of the clusters. For each segment, the computing device may determine a correlation score (110). For example, the correlation score for each segment may be based on the cluster variations and the total variations computed for the segment. After the correlation score is determined for the current product and the current segmentation strategy, the process shown in FIG. 4 may be repeated for the current product and one or more other segmentation strategies. For each product, the computing device may generate one or more reports based on the analysis (112). For example, reports may be generated based on the cluster variations, the total variations, and/or the correlation scores calculated for each segmentation strategy. The process of FIG. 4 may further be repeated for the same product for each of a plurality of segments, and may also be repeated for each of a plurality of products.

The operations illustrated in the example process of FIG. 4 may be executed by SSC engine 19 of computing device 30. Alternatively, one or more of the various operations may be executed by one or more of sales data module 46, segmentation module 48, correlation module 50, and/or reporting module 52. However, these and other operations may be carried out by other computing devices including different physical and logical configurations than computing device 30, and the disclosure is not limited in this respect.

The method of FIG. 4 includes receiving past sales data for a product (100). In one example, sales data module 46 of SSC engine 19 is configured to retrieve, receive, or otherwise reference actual sales transaction data corresponding to sales of products or other items at a number of different stores of the retailer. For example, sales data module 46 may receive or retrieve sales data from POS system 21 and/or data repository 16.

The sales data retrieved by sales data module 46 may indicate a variety of information related to the sale of products at the stores of the retailers. For example, the sales data retrieved by sales data module 46 may include the number of units sold, the sale price of each unit, the total sales dollars, and profit for a particular time period over which the sales data was gathered, and/or other information related to product sales. For example, the sales data may be referenced to determine a measure of sales of different products in different stores of the retailer, which may then be correlated with different segmentation strategies. The sales measure may include, for example, the number of units sold or the amount of sales revenue or profit realized as a result of such sales.

One or more of the segmentation strategies may be specific to or customized for each retailer. Thus, different retailers may segment and cluster stores in different ways and based on different segmentation criteria. In some examples, segmentation strategies may be predefined by retailers such that segmentation module 48 executes a predefined command or set of commands to group all of the retailer's stores into predefined clusters. It shall be understood that many different segmentation strategies may be employed and that the disclosure is not limited in this respect.

FIG. 5 is an example report 150 for a product (Laptop Computer, SKU 548902 in this example). Example report 150 shows the results of an analysis for this product in the BTC segment. In this example, there are five clusters of stores (Clusters 1-5), each containing 5 individual stores (Store IDs 1-25). Example report 150 shows the cluster variation for each store, the total variation for each store, and the correlation score of this example segmentation strategy for this particular product in the BTC segment. In this example, unit sales of the laptop computer are used as the measure of product sales. However, as noted above, other sales measures could be used in other examples.

Example report 150 shows the cluster average sales computed for each cluster. In this example, cluster average sales of the laptop computer in Cluster 1 is 4.2, cluster average sales of the laptop computer in Cluster 2 is 12.8, cluster average sales of the laptop computer in Cluster 3 is 2.4, cluster average sales of the laptop computer in Cluster 4 is 9.2, and cluster average sales of the laptop computer in cluster 5 is 12.6.

Example report 150 also shows the cluster variation computed for each store. In example report 150, the cluster variation for each store is computed using the following equation:

Cluster Variation=[(Cluster Average Sales)−(Store Unit Sales)]

Thus, the cluster variation for Store 1 in this example is calculated using the above equation as follows:

Cluster Variation(Store 1)=[(4.2)−(5)]²=0.64

The cluster variation for each store is indicative of the amount of sales variation within the cluster that the segmentation strategy can reduce. If every single store were clustered with itself, the cluster variation would be 0, which means there would be no variation in every cluster. Thus, if the cluster variations for each of the stores in a cluster were to have values of zero (0), this would mean that the segmentation strategy eliminated all variation within that cluster. In general, a higher value for the cluster variation means that the segmentation strategy was relatively less successful in eliminating variation across the stores in the cluster. If all of the stores were assigned to one cluster, this number will be the same as the Total Variation, described below.

Example report 150 also shows the average sales over all 25 stores. The average sales for all stores is shown in example report 150 as “All Stores Avg” and is equal to 7.24 in this example.

Example report 150 also shows the total variation computed for each store. In example report 150, the total variation is computed for each store using the following equation:

Total Variation=[(All Stores Average Sales)−(Store Unit Sales)]

In this example, the total variation for Store 1 is calculated using the above equation as follows:

Total Variation(Store 1)=[(7.24)−(5)]²=5.02

The total variation in this example is thus based on the total difference between store individual sales and the total average sales. In general, the total variation is a normalization base by which to normalize Cluster Variation into scale of 0 and 1 as will be shown below.

Example report 150 also shows the sum of the cluster variations and the sum of the total variations for all of the stores. The sum of the cluster variations for all of the stores is shown in report 150 as “Sum (Cluster Variations)” and is equal to 296.8 in this example. The sum of the total variations for all of the stores is shown in report 150 as “Sum (Total Variations)” and is equal to 772.5424 in this example.

Example report 150 also shows the correlation score computed for the segmentation strategy. The correlation score may be indicative of the proportion of variation among the clusters as a proportion of the total variation. In example report 150, the correlation score is determined using the following equation:

$$Correlation Score = 1 - \frac{\sum ( Cluster Variations )}{\sum ( Total Variations )}$$

In this example, the correlation score is calculated as follows:

$$Correlation Score = 1 - \frac{( 296.8 )}{( 772.5424 )} = 0.615813967$$

The correlation score is indicative of the amount of sales variation that the segmentation strategy can reduce. That is, the correlation score may be indicative of an effectiveness of the segmentation strategy to reduce sales variation among stores in each of the plurality of clusters. In general in this example, the higher the correlation score, the more sales variation within the clusters that the segmentation strategy can reduce. Thus, if the cluster variation had a value of zero (0), the correlation score would be 1, indicating that the segmentation strategy eliminated all sales variation within the clusters. A correlation score closer to zero (0) would indicate a high level of sales variation among stores within each cluster for that particular segmentation strategy.

After the correlation score is determined for the product and one segmentation strategy as described above, the process of FIG. 4 may be repeated for a number of different segmentation strategies to determine a correlation score for each segmentation strategy applied to the product. Thus, for the laptop computer described with reference to FIG. 5, SSC engine 19 may determine correlation scores for one or more of a climate segment, a volume segment, a young singles segment, etc. Additionally, SSC engine 19 may repeat the process of FIG. 4 or another similar process in accordance with this disclosure for one or more other products sold by the retailer.

As discussed above, the example process described with respect to FIG. 4 also includes generating one or more reports (112). To do so, SSC engine 19 may compare the correlation scores calculated for each segmentation strategy to generate a sales-to-segment correlation report for the product. For example, SSC engine 19 may compare a first correlation score for a product to a second correlation score for the product and determine which of the first correlation score and the second correlation score is greater based on the comparison. Correlation module 50 may repeat this process for each segmentation strategy to generate one or more reports.

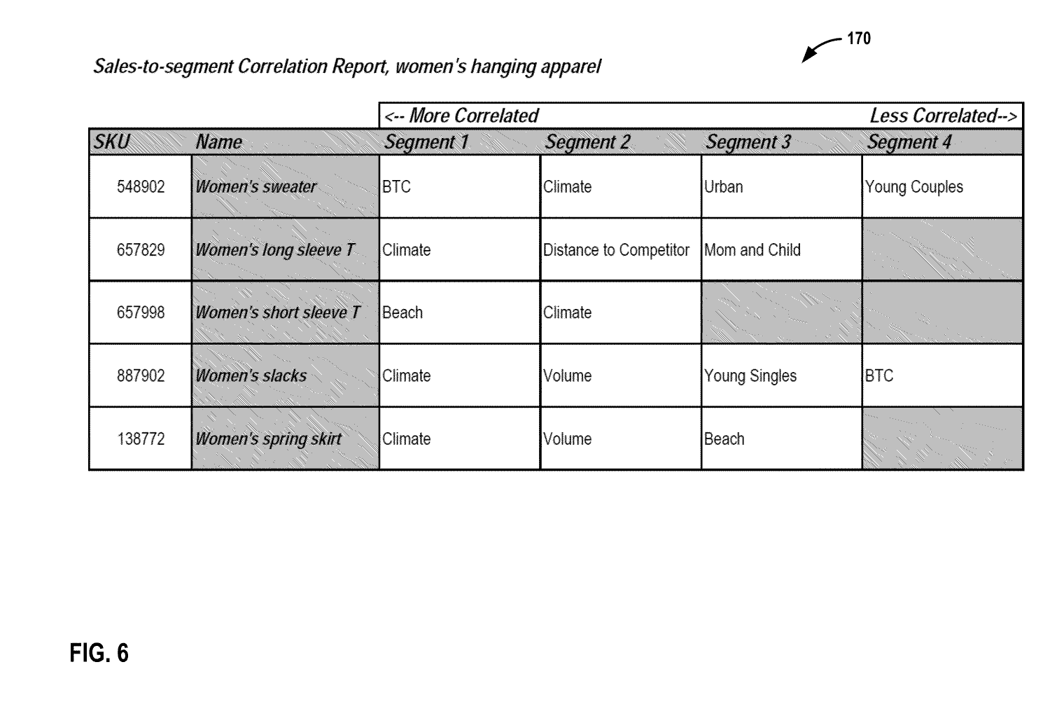

FIG. 6 shows an example sales-to-segment correlation report 170 for five different women's clothing items, including a women's sweater, a women's long sleeve T-shirt, a women's short sleeve T-shirt, women's slacks, and a women's spring skirt. In the example of FIG. 6, SSC engine 19 has ordered the segmentation strategies for each of the items in terms of their correlation score. That is, for each item, the segments are presented in a ranked order with the highest correlation score segment in the “Segment 1” column. The segment that are relatively more closely correlated with the item to the left of the report and the segments that are relatively less closely correlated with the item to the right of the report. For example, the women's sweater has been determined to be most closely correlated with the BTC segment, and then less closely correlated with the climate segment, the urban segment, and the young couples segment, in order of decreasing correlation.

The example SSC report 170 of FIG. 6 and other such reports in accordance with this disclosure for may assist the retailer in evaluating different segmentation strategies on a product-by-product basis, as well as for evaluating different segmentation strategies for a number of related products such as products in a common category or sold in a common department within the stores of the retailer. For example, the retailer could determine from the SSC report of FIG. 6 that the women's long sleeve T-shirt, slacks, and spring skirt are most closely correlated with the climate segment. In this case, the retailer may decide to determine product inventory levels for each of these items using the climate segmentation strategy. The women's sweater and short sleeve T-shirt, on the other hand, are most closely correlated with the BTC and beach segments, respectively, but are both second-most correlated with the climate segment. In this case, the retailer may decide whether or not the cost of implementing different segmentation strategies for the women's sweater and short sleeve T-shirt is worth the incremental sales increase realized as a result of such increased complexity in segmentation.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various operations and functions described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

In some examples, computer-readable storage media may comprise non-transitory media. The term “non-transitory” may indicate that the storage medium is not embodied in a carrier wave or a propagated signal. In certain examples, a non-transitory storage medium may store data that may, over time, change (e.g., in RAM or cache).

Various examples have been described. These and other examples are within the scope of the following claims.

1. A method comprising:
receiving, by a computing device, past sales data for a product sold at a plurality of stores;
assigning each of the plurality of stores to one of a plurality of clusters based on a segmentation strategy;
calculating a cluster average sales of the product for each of the plurality of clusters based on the past sales data for each of the stores assigned to the cluster;
for each of the plurality of stores, calculating a cluster variation based on a difference between actual sales of the product in the store indicated by the past sales data and the calculated cluster average sales for the cluster to which the store is assigned;
calculating a total average sales of the product based on the past sales data for each of the plurality of stores and the total number of stores in the plurality of stores;
for each of the plurality of stores, calculating a total variation based on a difference between actual sales of the product in the store and the calculated total average sales; and
determining a correlation score based on the cluster variation and the total variation, the correlation indicative of an effectiveness of the segmentation strategy to reduce sales variation for the product between stores in each of the plurality of clusters.

2. The method of claim 1, wherein the segmentation strategy comprises a first segmentation strategy and the correlation score is a first correlation score corresponding to the first segmentation strategy, and further comprising:
assigning each of the plurality of stores to a one of a second plurality of clusters based on a second segmentation strategy;
determining a second correlation score indicative of an effectiveness of the second segmentation strategy to reduce sales variation between stores in each of the second plurality of clusters.

3. The method of claim 3, further comprising:
comparing the first correlation score and the second correlation score; and
determining which of the first correlation score and the second correlation score is greater based on the comparison.

4. The method of claim 3, further comprising:
generating a report including the first correlation score and the second correlation score.

5. The method of claim 1, wherein the product is a first product, and further comprising:
receiving, by the computing device, past sales data for a second product sold at the plurality of stores; and
determining a correlation score for the second product.

6. The method of claim 4, further comprising generating a report including a ranking of the first segmentation strategy and the second segmentation strategy based on the first correlation score and the second correlation score.

7. The method of claim 1, wherein the cluster variation is determined according to the equation:
Cluster Variation=[(Cluster Average Sales)−(Store Unit Sales)].

8. The method of claim 1, wherein the total variation is determined according to the equation:
Total Variation=[(All Stores Average Sales)−(Store Unit Sales)].

9. The method of claim 1, wherein the correlation score is determined according to the equation:
$$Correlation Score = 1 - \frac{\sum ( Cluster Variations )}{\sum ( Total Variations )} .$$

10. The method of claim 1 wherein the segmentation strategy includes at least one of a sales volume, a climate, a distance to a competitor store, a geographic location, a back to school, an area type, or a targeted guest group.

11. A system comprising:
at least one computer-readable storage device that stores sales data associated with a product sold at a plurality of stores, that stores a first segmentation strategy that assigns each of the plurality of stores to one of a first plurality of clusters within a first segment, and that stores a second segmentation strategy that assigns each of the plurality of stores to one of a second plurality of clusters within a second segment;
at least one processor configured to access the sales data on the at least one computer-readable storage device, and further configured to:
determine a first correlation score for the first segment based on the sales data, the first correlation score indicative of an effectiveness of the first segmentation strategy to reduce sales variation for the product between stores in each of the first plurality of clusters;
determine a second correlation score for the second segment based on the sales data, the second correlation score indicative of an effectiveness of the second segmentation strategy to reduce sales variation for the product between stores in each of the second plurality of clusters; and
generate a report based on the first correlation score and the second correlation score.

12. The system of claim 11, wherein the at least one processor is further configured to:
for each of the first plurality of clusters in the first segment, calculate a first cluster average sales of the product based on the past sales data associated with each of the stores assigned to the cluster; and
for each of the second plurality of clusters in the second segment, calculate a second cluster average sales of the product based on the past sales data associated with each of the stores assigned to the cluster.

13. The system of claim 12, wherein the at least one processor is further configured to:
for each of the plurality of stores, calculate a first cluster variation based on a difference between actual sales of the product in the store and the first cluster average sales calculated for the one of the first plurality of clusters to which the store is assigned;
for each of the plurality of stores, calculate a first total variation based on a difference between actual sales of the product in the store and a first total average sales of the product in the plurality of stores;
for each of the plurality of stores, calculate a second cluster variation based on a difference between actual sales of the product in the store and the second cluster average sales calculated for the one of the second plurality of clusters to which the store is assigned; and
for each of the plurality of stores, calculate a second total variation based on a difference between actual sales of the product in the store and a second total average sales of the product in the plurality of stores.

14. The system of claim 13, wherein the at least one processor is further configured to:
determine the first correlation score for the first segment based on the first cluster variation and the first total variation; and
determine the second correlation score for the first segment based on the second cluster variation and the second total variation.

15. The system of claim 11, wherein the at least one processor is further configured to:
compare the first correlation score and the second correlation score; and
determine which of the first correlation score and the second correlation score is greater based on the comparison.

16. A non-transitory computer-readable storage medium encoded with instructions that, when executed by one or more processors, cause the one or more processors of a computing device to:
receive, by a computing device, past sales data for a product sold at a plurality of stores;
assign each of the plurality of stores to one of a plurality of clusters based on a segmentation strategy;
calculate a cluster average sales of the product for each of the plurality of clusters based on the past sales data for each of the stores assigned to the cluster;
for each of the plurality of stores, calculate a cluster variation based on a difference between actual sales of the product in the store indicated by the past sales data and the calculated cluster average sales for the cluster to which the store is assigned;
calculate a total average sales of the product based on the past sales data for each of the plurality of stores and the total number of stores in the plurality of stores;
for each of the plurality of stores, calculate a total variation based on a difference between actual sales of the product in the store and the calculated total average sales; and
determine a correlation score based on the cluster variation and the total variation, the correlation indicative of an effectiveness of the segmentation strategy to reduce sales variation for the product between stores in each of the plurality of clusters.

17. The non-transitory computer-readable storage medium of claim 16, wherein the segmentation strategy comprises a first segmentation strategy and the correlation score is a first correlation score corresponding to the first segmentation strategy, and further encoded with instructions that cause the one or more processors to:
assign each of the plurality of stores to a one of a second plurality of clusters based on a second segmentation strategy; and
determine a second correlation score indicative of an effectiveness of the second segmentation strategy to reduce sales variation between stores in each of the second plurality of clusters.

18. The non-transitory computer-readable storage medium of claim 17, further encoded with instructions that cause the one or more processors to:
compare the first correlation score and the second correlation score; and
determine which of the first correlation score and the second correlation score is greater based on the comparison.

19. The non-transitory computer-readable storage medium of claim 17, further encoded with instructions that cause the one or more processors to generate a report including the first correlation score and the second correlation score.

20. The non-transitory computer-readable storage medium of claim 17, further encoded with instructions that cause the one or more processors to generate a report including a ranking of the first segmentation strategy and the second segmentation strategy based on the first correlation score and the second correlation score.
